(19) United States
(12) Patent Application Publication
(10) Pub. No.: US 2012/0159024 A1
(43) Pub. Date: Jun. 21, 2012

(54) SEMICONDUCTOR APPARATUS

(75) Inventors: Takeo MORITA, Tokyo (JP); Kazuma FUJIWARA, Kanagawa (JP)

(73) Assignee: KABUSHIKI KAISHA TOSHIBA, Tokyo (JP)

(21) Appl. No.: 13/237,379

(22) Filed: Sep. 20, 2011

(30) Foreign Application Priority Data
Dec. 15, 2010 (JP) 2010-279006

(51) Int. Cl. G06F 13/40

(52) U.S. Cl. 710/110

(57) ABSTRACT

According to one embodiment, a semiconductor apparatus including a slave device which includes a plurality of slave interfaces, an adjustment unit, a processing unit, and a processing unit. The plurality of slave interfaces are connected to the bus to receive transmission instructions from master devices at the first frequency. The adjustment unit decides a processing sequence of the transmission instructions which are received through the plurality of slave interfaces according to priority information. On priority information, a plurality of master devices are prioritized in a sequence depending on association of processing content among the plurality of master devices. The processing unit performs a data transmission process corresponding to a transmission instruction at a second frequency according to the processing sequence decided by the adjustment unit. The transmission instruction instructs to transform data to/from a module. The second frequency is higher than the first frequency.

### CROSS-REFERENCE TO RELATED APPLICATIONS

This application is based upon and claims the benefit of priority from Japanese Patent Application No. 2010-279006, filed on Dec. 15, 2010; the entire contents of which are incorporated herein by reference.

### FIELD

Embodiments described herein relate generally to a semiconductor apparatus.

### BACKGROUND

In a system in which a plurality of masters are connected to a high speed memory through a low speed bus and a memory controller, a memory I/F in the memory controller connected to the high speed memory needs to (efficiently) operate at a high operation speed corresponding to the high speed memory. However, in this system, when transmission instructions (requests for accessing to the high speed memory) are simultaneously output from the plurality of masters to the memory controller, a slave interface in the memory controller connected to a bus operates at a low speed similarly to the low speed bus, resulting in the occurrence of a spare time for which the memory I/F in the memory controller does not perform a data transmission process with respect to the high speed memory. Therefore, the operation efficiency of the system may be reduced.

### BRIEF DESCRIPTION OF THE DRAWINGS

FIG. 1 is a diagram illustrating a configuration of a data transmission system according to a first embodiment;

FIG. 2 is a diagram illustrating a configuration of a priority designation table according the first embodiment;

FIG. 3 is a flowchart illustrating an operation of a data transmission system according to the first embodiment;

FIG. 4 is a timing chart illustrating the operation of the data transmission system according to the first embodiment;

FIG. 5 is a diagram illustrating a configuration of a data transmission system according to a second embodiment;

FIG. 6 is a diagram illustrating a configuration of a data transmission system according to a third embodiment;

FIG. 7 is a diagram illustrating a configuration of a determination table according the third embodiment;

FIG. 8 is a diagram illustrating a configuration of a data transmission system according to a comparative example; and

FIG. 9 is a timing chart illustrating an operation of a data transmission system according to the comparative example.

### DETAILED DESCRIPTION

In general, according to one embodiment, there is provided a semiconductor apparatus including a bus, a plurality of master devices, and a slave device. The bus includes a plurality of lines. The bus transmits data at a first frequency. The plurality of master devices are connected to the bus. The slave device is connected to the bus. The slave device includes a plurality of slave interfaces, an adjustment unit, a processing unit, and a processing unit. The plurality of slave interfaces are connected to the bus to receive transmission instructions from the master devices at the first frequency through the bus. The adjustment unit decides a processing sequence of the transmission instructions which are received through the plurality of slave interfaces according to priority information. On priority information, the plurality of master devices are prioritized in a sequence depending on association of processing content among the plurality of master devices. The processing unit performs a data transmission process corresponding to a transmission instruction at a second frequency according to the processing sequence decided by the adjustment unit. The transmission instruction instructs to transform data to/from a module. The second frequency is higher than the first frequency.

Exemplary embodiments of a semiconductor apparatus will be explained below in detail with reference to the accompanying drawings. The present invention is not limited to the following embodiments.

### First Embodiment

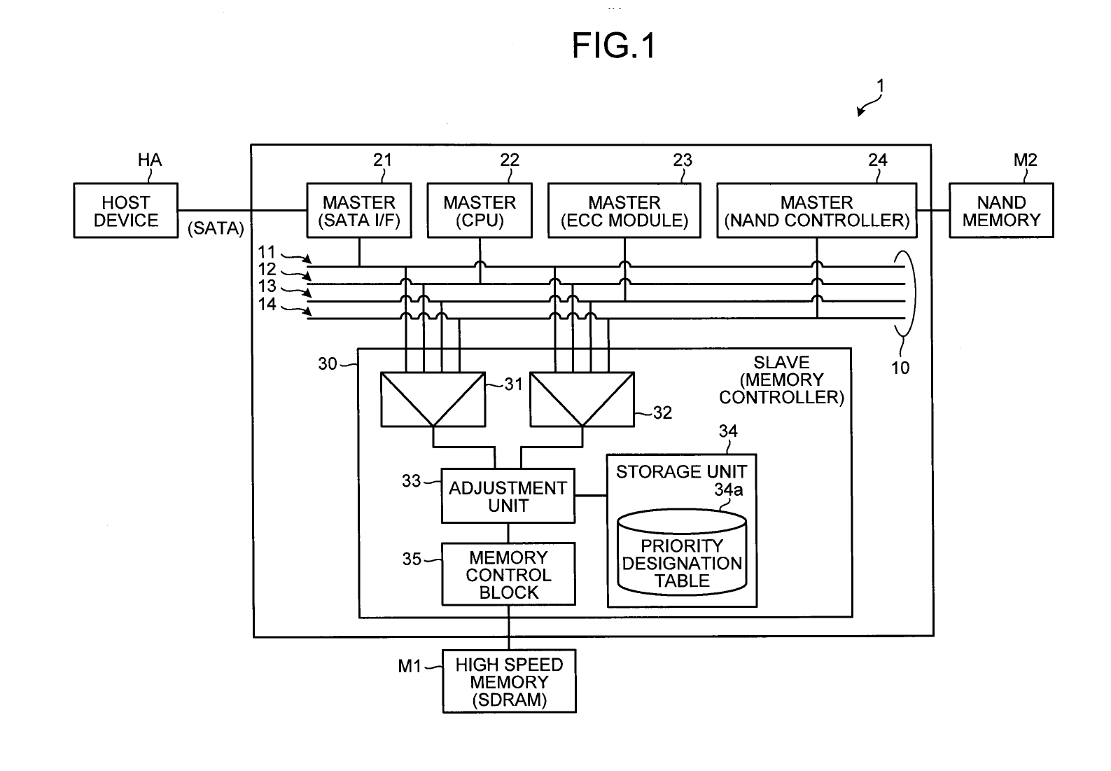

A data transmission system 1 according to a first embodiment will be described with reference to FIG. 1. FIG. 1 is a diagram illustrating the configuration of the data transmission system 1 according to the first embodiment.

The data transmission system 1 includes a bus 10, a plurality of master devices 21 to 24, and a slave device 30.

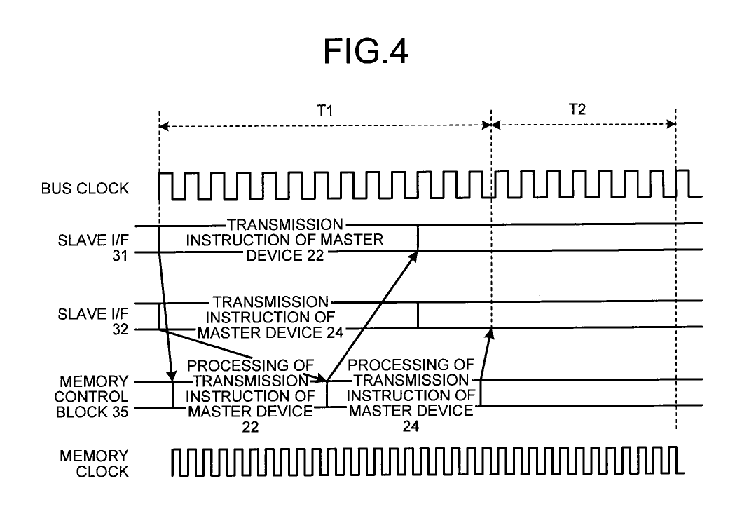

The bus 10 connects the plurality of master devices 21 to 24 to the slave device 30, and mediates communication between the plurality of master devices 21 to 24 and the slave device 30. The bus 10 includes a plurality of lines 11 to 14 which transmit data at a first frequency, respectively. The bus 10, for example, conforms to an AHB (Advanced High-Performance Bus) standard, and the first frequency, for example, is 100 MHz. That is, the frequency of a bus clock (refer to FIG. 4) provided to the bus 10, for example, is 100 MHz. Furthermore, the bus 10 transmits data in units of sectors (512B).

The plurality of master devices 21 to 24 are connected to the bus 10. Each of the master devices 21 to 24 serves as a subject for actively performing data transmission with respect to the slave device 30 through the bus 10. For example, each of the master devices 21 to 24 transmits a transmission instruction to the slave device 30 through the bus 10.

The master device 21, for example, is a SATA I/F. For example, the master device 21 transmits a transmission instruction (a write instruction), which is used for writing a command, data and the like received from a host device HA through an external bus (SATA) on a high speed memory M1, to the slave device 30 through the bus 10, and transmits a transmission instruction (a read instruction), which is used for reading data to be transmitted to the host device HA from the high speed memory M1, to the slave device 30 through the bus 10. That is, the transmission instruction instructs the slave device 30 to transform data to/from the high speed memory M1. The master device 21 transmits data and the like, which have been received through the bus 10, to the host device HA through the external bus (SATA).

The master device 22, for example, is a CPU. For example, since the master device 22 comprehensively controls each element of the data transmission system 1, when receiving a command from the host device HA through the master device (SATA I/F) 21 and the bus 10, the master device 22 performs control according to the command. For example, the master device 22 transmits a transmission instruction (e.g., a write instruction), which is used for writing data read from a NAND flash memory (hereinafter, referred to as a NAND memory) M2 on the high speed memory M1, to the slave device 30 through the bus 10, and transmits a transmission instruction (e.g., a read instruction), which is used for reading data to be written on the NAND memory M2 from the high speed memory M1, to the slave device 30 through the bus 10 in cooperation with the master device (a NAND controller) 24 according to the command from the host device HA.

The master device 23, for example, is an ECC module. For example, the master device 23 transmits a transmission instruction (e.g., a write instruction), which is used for writing data having experienced an ECC process (an error correction process) on the high speed memory M1, to the slave device 30 through the bus 10, and transmits a transmission instruction (e.g., a read instruction), which is used for reading data to be subject to the ECC process (error correction process) from the high speed memory M1, to the slave device 30 through the bus 10 in cooperation with the master device (CPU) 22 and the master device (NAND controller) 24.

The master device 24, for example, is the NAND controller. For example, the master device 24 controls data transmission between the NAND memory M2 and the high speed memory M1. For example, the master device 24 transmits a transmission instruction (e.g., write instruction), which is used for writing data read from the NAND memory M2 on the high speed memory M1, to the slave device 30 through the bus 10, and transmits a transmission instruction (e.g., read instruction), which is used for reading data to be written on the NAND memory M2 from the high speed memory M1, to the slave device 30 through the bus 10 in cooperation with the master device (CPU) 22.

It should be noted that the data transmission system 1, the high speed memory M1, and the NAND memory M2 as a whole serve as a semiconductor apparatus, and specifically serve as an external storage medium apparatus for the host device HA, and for example, are a SSD (solid state drive). The host device HA, for example, includes a personal computer or a CPU core.

The high speed memory M1, for example, serves as a cache area for data transmission between the host device HA and the NAND memory M2, and as a working area used by the master device (CPU) 22. The high speed memory M1, for example, includes a DRAM (dynamic random access memory), a FeRAM (ferroelectric random access memory), a MRAM (magnetoresistive random access memory), and a PRAM (phase change random access memory). Specifically, the high speed memory M1, for example, may be a DDR3-SDRAM.

The NAND memory M2 includes a memory cell array in which a plurality of memory cells are arranged in a matrix form, wherein each memory cell can perform multi-value storage using an upper page and a lower page. In the NAND memory M2, while data erase is performed in units of blocks, data write and data read are performed in units of pages. The block denotes a unit in which a plurality of pages are integrated together. Furthermore, in the NAND memory M2, internal data management is performed by the master device (CPU) 22 in units of clusters and data update is performed in units of sectors. In this embodiment, the page denotes a unit in which a plurality of clusters are integrated together, and the cluster denotes a unit in which a plurality of sectors are integrated together. The sector denotes a minimum access unit of data from the host device HA, and for example, has a size of 512B. The host device HA designates data to be accessed by a sector-unit LBA (logical block addressing).

Furthermore, the plurality of master devices 21 to 24 may further include a DMA controller, an encryption module and the like.

The slave device 30 is connected to the bus 10. The slave device 30 passively waits for the transmission instructions from the master devices 21 to 24, and receives a data transmission service provided by the master devices 21 to 24. That is, the slave device 30 receives the transmission instruction from each of the master devices 21 to 24.

The slave device 30, for example, is a memory controller. That is, the slave device 30 controls data write to the high speed memory M1 and data read from the high speed memory M1 according to the transmission instruction received from each of the master devices 21 to 24.

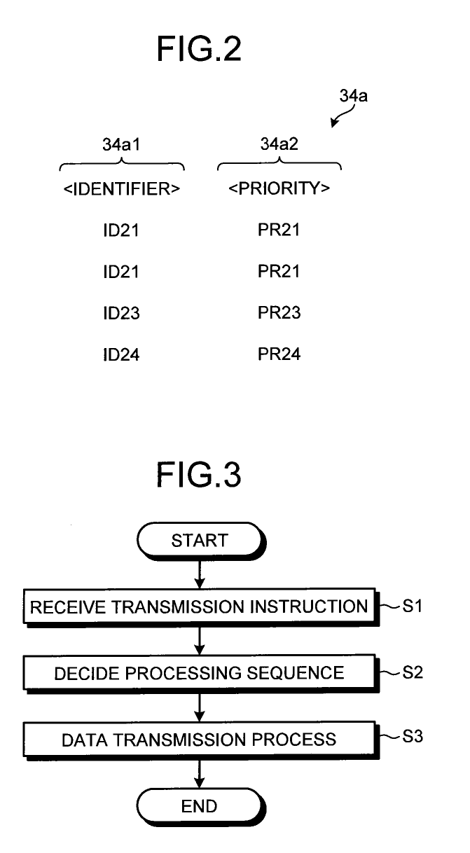

Next, the configuration of the slave device 30 will be described with reference to FIGS. 1 and 2. FIG. 2 is a diagram illustrating the configuration of a priority designation table 34a according the first embodiment.

As illustrated in FIG. 1, the slave device 30 includes a plurality of slave interfaces 31 and 32, a storage unit 34, an adjustment unit 33, and a memory control block 35.

The plurality of slave interfaces 31 and 32 are connected to the bus 10, respectively. That is, the slave interface 31 is connected to the lines 11 to 14 of the bus 10, and the slave interface 32 is also connected to the lines 11 to 14 of the bus 10.

The slave interfaces 31 and 32 independently establish a communication with different master devices 21 to 24, respectively. Each of the slave interfaces 31 and 32 receives the transmission instruction from the master devices 21 to 24 at a first frequency. The first frequency, for example, is 100 MHz. That is, each of the slave interfaces 31 receives a bus clock, which is the same as that provided to the bus 10, as a clock. The frequency of the bus clock (refer to FIG. 4) provided to each of the slave interfaces 31, for example, is 100 MHz. Furthermore, each of the slave interfaces 31 and 32 receives data from the master devices 21 to 24 in units of sectors (512B), and transmits data to the master devices 21 to 24 in units of sectors (512B).

The storage unit 34 stores the priority designation table (priority information) 34a. The priority designation table 34a, for example, is a table for designating priorities decided in advance to the plurality of master devices 21 to 24, and is a table in which the plurality of master devices 21 to 24 are prioritized in a sequence depending on the associations of processing contents among the plurality of master devices 21 to 24.

Specifically, as illustrated in FIG. 2, the priority designation table 34a includes an identifier field 34a1 and a priority field 34a2. In the identifier field 34a1, identifiers ID21 to ID24 of the master devices 21 to 24 are recorded. In the priority field 34a2, priorities PR21 to PR24 of corresponding master devices 21 to 24 are recorded. The priorities PR21 to PR24 of the master devices 21 to 24 have been decided in the sequence depending on the associations of the processing contents (e.g., in a series of processes of interest) in the plurality of master devices 21 to 24.

The adjustment unit 33 refers to the priority designation table 34a stored in the storage unit 34, and decides the processing sequence of the transmission instructions, which have been received through the slave interfaces 31 and 32, according to the priority designation table 34a.

Specifically, the adjustment unit 33 adjusts a transmission instruction to the memory control block 35 from the plurality of slave interfaces 31 and 32. That is, the adjustment unit 33 decides the processing sequence of the transmission instructions, which have been received through the slave interfaces 31 and 32, according to the priority designation table 34a. In other words, the adjustment unit 33 sequentially selects from a master device with a high priority to a master device with a low priority in a cyclic manner (i.e., in a round robin scheduling) in the priority designation table 34a, and decides the processing sequence in the sequence of the selected master devices with respect to the transmission instructions received through the plurality of slave interfaces 31 and 32.

Then, the adjustment unit 33 gives an access right to a plurality of transmission instructions, which have been received through the plurality of slave interfaces 31 and 32, in the decided processing sequence, and sequentially provides the transmission instructions to the memory control block 35.

The memory control block 35 performs a data transmission process with respect to the high speed memory (module) M1 corresponding to the transmission instructions at a second frequency according to the processing sequence decided by the adjustment unit 33.

Specifically, the memory control block 35 performs the data transmission process corresponding to the transmission instructions provided from the adjustment unit 33.

For example, when the transmission instruction is a write instruction, the memory control block 35 writes predetermined data in the high speed memory M1 according to the write instruction. For example, when the transmission instruction is a read instruction, the memory control block 35 reads predetermined data from the high speed memory M1 according to the read instruction.

It should be noted that when the high speed memory M1 is a DDR3-SDRAM. Although DDR3 specification defines an operation frequency of DDR3-SDRAM as a frequency among 400 MHz-300 MHz, this embodiment exemplifies a case where a minimum operation frequency of the high speed memory M1 is, for example, 333 MHz. That is, the frequency of a memory clock (refer to FIG. 4) provided to the high speed memory M1 is, for example, 333 MHz.

In this regard, the memory control block 35 is requested to operate at a high operation speed corresponding to the high speed memory M1. That is, the second frequency according to the memory control block 35 is higher than the first frequency (e.g., 100 MHz) according to the bus 10, and for example, is 133 MHz. That is, the frequency of a clock (not illustrated) provided to the memory control block 35, for example, is 333 MHz.

Next, the operation of the data transmission system 1 will be described with reference to FIG. 3. FIG. 3 is a flowchart illustrating the operation of the data transmission system 1.

Before step S1, the storage unit 34 stores in advance the priority designation table (priority information) 34a. The priority designation table 34a, for example, is a table for designating priorities decided in advance to the plurality of master devices 21 to 24, and is a table in which the plurality of master devices 21 to 24 are prioritized in the sequence depending on the associations of processing contents among the plurality of master devices 21 to 24.

Specifically, as illustrated in FIG. 2, the priority designation table 34a includes an identifier field 34a1 and a priority field 34a2. In the identifier field 34a1, the identifiers ID21 to ID24 of the master devices 21 to 24 are recorded. In the priority field 34a2, the priorities PR21 to PR24 of the master devices 21 to 24 are recorded. The priorities PR21 to PR24 of the master devices 21 to 24 have been decided in the sequence depending on the associations of the processing contents (e.g., in a series of processes of interest) in the plurality of master devices 21 to 24.

For example, there may be a case which places emphasis on a series of processes where the master device (CPU) 22 and the master device (NAND controller) 24 perform operations in cooperation with each other such that cluster-unit data (includes a plurality of sectors) which has been read from the NAND memory M2 is written to the high speed memory M1 or cluster-unit data which is to be written in the NAND memory M2 is read from the high speed memory M1. In such a case, in the series of processes, the process performed by the master device (CPU) 22 and the process performed by the master device (NAND controller) 24 are alternately performed. As a sequence depending on the association of such processing content, the priorities of the master devices 21 to 24, for example, are decided as a priority PR21 (=1), a priority PR22 (=2), a priority PR23 (=3), and a priority PR24 (=4), respectively, (refer to FIG. 2).

In step S1, the slave interfaces 31 and 32 of the salve device 30 independently establish communication with different master devices 21 to 24, respectively. The plurality of slave interfaces 31 and 32 receive transmission instructions from the different master devices 21 to 24 at a first frequency within a predetermined time at which receptions can be considered to be performed simultaneously. The first frequency, for example, is 100 MHz.

For example, the plurality of slave interfaces 31 and 32 receive the transmission instructions from the master devices 21 to 24 within the predetermined time at which receptions can be considered to be performed simultaneously.

In step S2, the adjustment unit 33 refers to the priority designation table 34a stored in the storage unit 34, and decides the processing sequence of the transmission instructions, which have been received through the slave interfaces 31 and 32, according to the priority designation table 34a.

Specifically, the adjustment unit 33 adjusts transmission instructions received through the plurality of slave interfaces 31 and 32. That is, the adjustment unit 33 decides the processing sequence of the transmission instructions, which have been received through the slave interfaces 31 and 32, according to the priority designation table 34a. In other words, the adjustment unit 33 sequentially selects from a master device with a high priority to a master device with a low priority in a cyclic manner (i.e., in a round robin scheduling) in the priority designation table 34a, and decides the processing sequence in the sequence of the selected master devices with respect to the transmission instructions received through the plurality of slave interfaces 31 and 32.

Then, the adjustment unit 33 gives an access right to the transmission instructions, which have been received through the plurality of slave interfaces 31 and 32, in the decided processing sequence, and sequentially provides the transmission instructions to the memory control block 35.

For example, in the priority designation table 34a, there may be a case where the priorities of the master devices 21 to 24 are decided as a priority PR21 (=1), a priority PR22 (=2), a priority PR23 (=3), and a priority PR24 (=4), respectively. At this time, in a predetermined time at which receptions can be considered to be performed simultaneously, if the transmission instruction from the master device 22 is received through the slave interface 31 and the transmission instruction from the master device 24 is received through the slave interface 32, the adjustment unit 33 refers to the priority designation table 34a, thereby deciding the processing sequence of transmission instructions such that the transmission instruction from the master device 22 and the transmission instruction from the master device 24 are alternately selected, regardless of the sequence of reception timings.

In step S3, the memory control block 35 performs a data transmission process with respect to the high speed memory (module) M1, which corresponds to the transmission instructions, at a second frequency according to the processing sequence decided by the adjustment unit 33.

Specifically, the memory control block 35 uses the transmission instruction provided from the adjustment unit 33 as a transmission instruction with an access right, and performs a data transmission process corresponding to the provided transmission instruction.

For example, the memory control block 35 alternately writes data corresponding to the transmission instruction from the master device 22 and data corresponding to the transmission instruction from the master device 24, on the high speed memory M1, according to the processing sequence decided by the adjustment unit 33. Also, for example, the memory control block 35 alternately reads data corresponding to the transmission instruction from the master device 22 and data corresponding to the transmission instruction from the master device 24, from the high speed memory M1, according to the processing sequence decided by the adjustment unit 33.

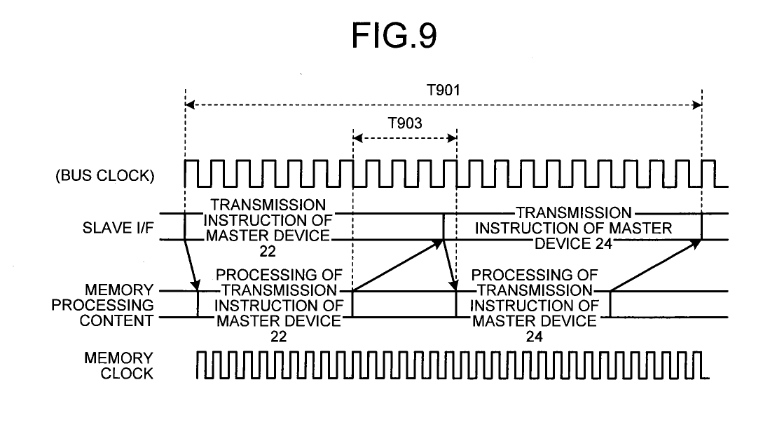

Consider a case where a slave device (memory controller) 930 includes one slave interface 931 and one memory control block 935 in a data transmission system 900 as illustrated in FIG. 8. At this time, if the high speed memory M1, for example, is a DDR3-SDRAM, a minimum operation frequency, for example, is 333 MHz. That is, as illustrated in FIG. 9, the frequency of a memory clock provided to the high speed memory M1, for example, is 333 MHz. In this regard, the memory control block 935 operates at a high speed operation frequency (e.g., 133 MHz) corresponding to the high speed memory M1. Even in such a case, as illustrated in FIG. 9, the frequency of a bus clock provided to the slave interface 931, for example, is 100 MHz.

That is, since the slave interface 931 operates at a low speed (the first frequency) as compared with the memory control block 935, there may be occurred a spare time for which the memory control block 935 in the a slave device (memory controller) 930 does not perform a data transmission process with respect to the high speed memory M1. For example, as illustrated in FIG. 9, when the slave interface 931 sequentially receives a transmission instruction of the master device 22 and a transmission instruction of the master device 24, the reception process of the transmission instruction of the master device 24 by the slave interface 931 does not start at the time at which the memory control block 935 has completed the processing of the transmission instruction of the master device 22. Therefore, the memory control block 935 receives the transmission instruction of the master device 24 to perform the processing of the transmission instruction of the master device 24 after waiting for time T903. Thus, when viewed from the entire data transmission system 900, since processing time T901 for the transmission instruction of the master device 22 and the transmission instruction of the master device 24 is increased, the operation efficiency of the data transmission system 900 is reduced.

In contrast, according to the first embodiment, the slave device (memory controller) 30 includes a plurality of slave interfaces 31 and 32, the adjustment unit 33, and the memory control block 35 in the data transmission system 1. As illustrated in FIG. 4, the plurality of slave interfaces 31 and 32 simultaneously receive transmission instructions from the plurality of master devices 21 to 24 at a low speed (the first frequency). The adjustment unit 33 decides the processing sequence of the transmission instructions, which have been received through the plurality of slave interfaces 31 and 32, according to the priority designation table 34a in which priorities have been given in advance to the plurality of master devices 21 to 24 in the sequence depending on the association of the processing content among the plurality of master devices 21 to 24. The memory control block 35 performs a data transmission process with the high speed memory (module) M1 corresponding to the transmission instructions at a high speed (the second frequency higher than the first frequency) according to the processing sequence decided by the adjustment unit 33.

That is, since the plurality of slave interfaces 31 and 32 can perform the reception operations in parallel even at the low speed (the first frequency) as compared with the memory control block 35, it is possible to reduce a spare time for which the memory control block 35 in the slave device (memory controller) 30 does not perform the data transmission process with respect to the high speed memory M1. The transmission instructions from the plurality of master devices 21 to 24 are received in parallel, so that it is possible to input a transmission instruction to be processed later to the slave device (memory controller) 30 even if the speed of the bus 10 is low. For example, as illustrated in FIG. 4, when both the reception process of the transmission instruction of the master device 22 by the slave interface 31 and the reception process of the transmission instruction of the master device 24 by the slave interface 32 are performed in parallel, the reception process of the transmission instruction of the master device 24 by the slave interface 32 has already started at the time at which the memory control block 35 has completed the processing of the transmission instruction of the master device 22. Therefore, as illustrated in FIG. 4, the memory control block 35 immediately (i.e. without waiting for time T903 as illustrated in FIG. 9) receives the transmission instruction of the master device 24 to perform the processing of the transmission instruction of the master device 24. Consequently, when viewed from the entire data transmission system 1, it is possible to reduce processing time T1 for the transmission instruction of the master device 22 and the transmission instruction of the master device 24 (e.g., processing time T1 can be reduced by the time T2 illustrated in FIG. 4 as compared with processing time T901 illustrated in FIG. 9), resulting in the improvement of the operation efficiency of the data transmission system 1.

Alternatively, consider a case where the adjustment unit 33 decides a processing sequence of transmission instructions such that the transmission instructions received through the plurality of slave interfaces 31 and 32 are processed in the reception sequence, in the data transmission system 1. In such a case, the processing sequence of the transmission instructions may be decided regardless of the associations of processing contents among the plurality of master devices 21 to 24.

For example, there may be a case which places emphasis on a series of processes where the master device (CPU) 22 and the master device (NAND controller) 24 perform operations in cooperation with each other such that cluster-unit data (includes a plurality of sectors) which has been read from the NAND memory M2 is written to the high speed memory M1 or cluster-unit data which is to be written in the NAND memory M2 is read from the high speed memory M1. In the series of processes, the process performed by the master device (CPU) 22 and the process performed by the master device (NAND controller) 24 are alternately performed. Even in such a case, if the plurality of slave interfaces 31 and 32 continuously receive a plurality of transmission instructions of the master device 24 after receiving a plurality of transmission instructions of the master device 22, the adjustment unit 33 decides a processing sequence of transmission instructions such that the plurality of transmission instructions of the master device 24 are positioned next to the plurality of transmission instructions of the master device 22. Therefore, after processing an initial transmission instruction of the plurality of transmission instructions of the master device 22, the memory control block 35 needs to perform a process of holding a following transmission instruction of the master device 22 and wait for a predetermined time until an initial transmission instruction of the plurality of transmission instructions of the master device 24 is received. Then, the memory control block 35 receives and processes the initial transmission instruction of the master device 24 while holding the following transmission instruction of the master device 22. That is, when viewed from the entire data transmission system 1, since the processing time for the plurality of transmission instructions of the master device 22 and the plurality of transmission instructions of the master device 24 is increased, the operation efficiency of the data transmission system 1 is reduced.

In contrast, according to the first embodiment, the adjustment unit 33 decides the processing sequence of the transmission instructions, which have been received through the plurality of slave interfaces 31 and 32, according to the priority designation table 34a in which priorities have been given in advance to the plurality of master devices 21 to 24 in the sequence depending on the association of the processing content among the plurality of master devices 21 to 24. The memory control block 35 performs a data transmission process with the high speed memory (module) M1 corresponding to the transmission instructions at a high speed (the second frequency higher than the first frequency) according to the processing sequence decided by the adjustment unit 33.

For example, as described above, in the case where a series of processes are emphasized in which the process performed by the master device (CPU) 22 and the process performed by the master device (NAND controller) 24 are alternately performed, even when the plurality of slave interfaces 31 and 32 continuously receive the plurality of transmission instructions of the master device 24 after receiving the plurality of transmission instructions of the master device 22, the adjustment unit 33 decides the processing sequence of transmission instructions such that the transmission instructions of the master device 22 and the transmission instructions of the master device 24 are alternately performed. In this way, after processing the initial transmission instruction of the plurality of transmission instructions of the master device 22, the memory control block 35 does not need to perform a process of holding a following transmission instruction of the master device 22 and wait for a predetermined time until the initial transmission instruction of the plurality of transmission instructions of the master device 24 is received. Then, the memory control block 35 receives and processes the initial transmission instruction of the master device 24 without holding the following transmission instruction of the master device 22. That is, when viewed from the entire data transmission system 1, it is possible to reduce the processing time for the plurality of transmission instructions of the master device 22 and the plurality of transmission instructions of the master device 24, resulting in the improvement of the operation efficiency of the data transmission system 1.

It should be noted that the slave device 30 may have two or more slave interfaces.

It should also be noted that, in the slave device 30, the priority designation table 34a stored in the storage unit 34, for example, may be a table in which the plurality of master devices 21 to 24 are prioritized in the sequence depending on the processing ability. For example, the priority designation table 34a may be a table in which the master devices 21 to 24 with the higher processing ability are prioritized as compared to the master devices 21 to 24 with the lower processing ability. In such a case, the adjustment unit 33 sequentially selects from a master device with a high priority to a master device with a low priority (from a master device with a high processing ability to a master device with a low processing ability in the plurality of master devices 21 to 24) in a cyclic manner (i.e., in a round robin scheduling) in the priority designation table 34a, and decides the processing sequence in the sequence of the selected master devices with respect to the transmission instructions received through the plurality of slave interfaces 31 and 32.

For example, when the processing ability has the following relation: the processing ability of the master device 21>the processing ability of the master device 22>the processing ability of the master device 23>the processing ability of the master device 24, there may be a case where the priorities of the master devices 21 to 24 are decided in advance as a priority PR21 (=1), a priority PR22 (=2), a priority PR23 (=3), and a priority PR24 (=4) in the priority designation table 34a, respectively. At this time, in a predetermined time at which receptions can be considered to be performed simultaneously, if the transmission instruction from the master device 22 is received through the slave interface 31 and the transmission instruction from the master device 24 is received through the slave interface 32, the adjustment unit 33 refers to the priority designation table 34a, thereby determining the processing sequence of transmission instructions such that the transmission instruction from the master device 22 and the transmission instruction from the master device 24 are alternately selected (a master device with a high processing ability and a master device with a low processing ability are alternately selected), regardless of the sequence of reception timings.

Then, for example, the adjustment unit 33 gives an access right to the plurality of transmission instructions, which have been received through the plurality of slave interfaces 31 and 32, in the decided processing sequence, and sequentially provides the transmission instructions to the memory control block 35.

In addition, the memory control block 35 alternately writes data corresponding to the transmission instruction from the master device 22 and data corresponding to the transmission instruction from the master device 24 on the high speed memory M1, according to the processing sequence decided by the adjustment unit 33. Also, the memory control block 35 alternately reads data corresponding to the transmission instruction from the master device 22 and data corresponding to the transmission instruction from the master device 24 from the high speed memory M1, according to the processing sequence decided by the adjustment unit 33.

Thus, the memory control block 35 sequentially processes from a master device with a high processing ability to a master device with a low processing ability in the plurality of master devices 21 to 24 in a cyclic manner (i.e., in a round robin scheduling). Consequently, when viewed from the entire data transmission system 1, it is possible to average loads when processing the transmission instructions of the plurality of master devices 21 to 24, resulting in the improvement of the operation efficiency of the data transmission system 1.

### Second Embodiment

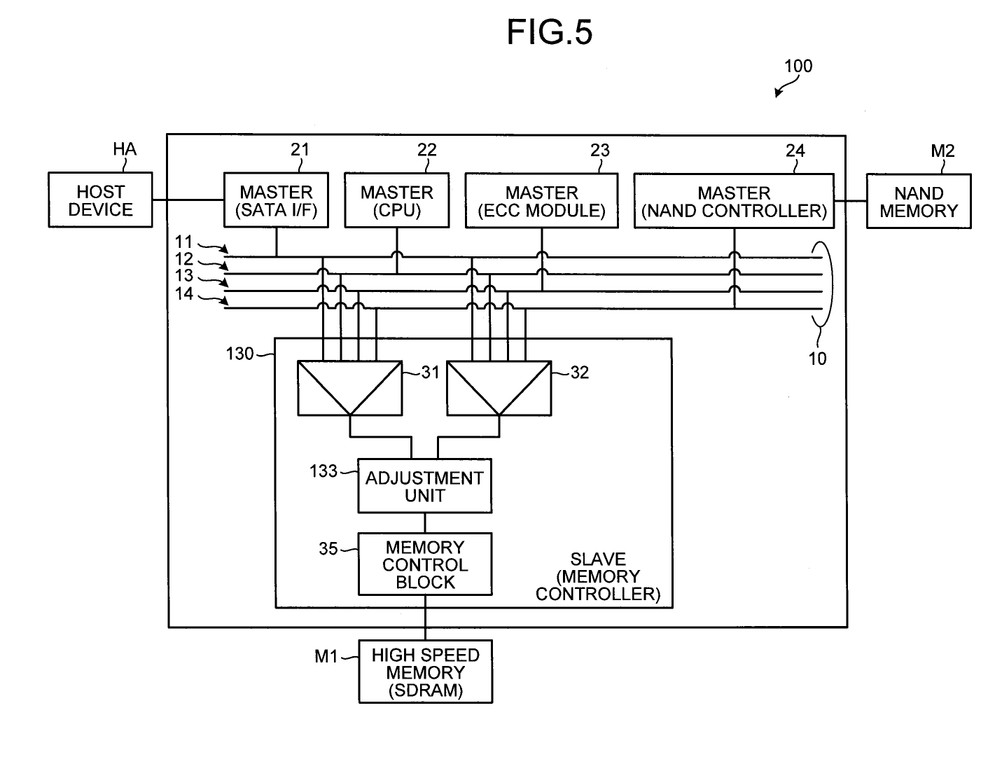

Next, a data transmission system 100 according to a second embodiment will be described with reference to FIG. 5. FIG. 5 is a diagram illustrating the configuration of the data transmission system 100 according to the second embodiment.

The data transmission system 100 includes a slave device 130. The slave device 130 does not include the storage unit 34 (refer to FIG. 1), but includes an adjustment unit 133. The adjustment unit 133 selects the plurality of slave interfaces 31 and 32 in a round robin scheduling, thereby deciding the processing sequence of transmission instructions received through the plurality of slave interfaces 31 and 32.

For example, a circuit (not illustrated) for adjusting the authority to use the bus 10 allocates the authority to use the bus 10 to different master devices 21 to 24 in a predetermined time for which receptions can be considered to be performed simultaneously among the plurality of slave interfaces 31 and 32. The plurality of slave interfaces 31 and 32 receive transmission instructions from the different master devices 21 to 24 within the predetermined time. At this time, the adjustment unit 133 selects the plurality of slave interfaces 31 and 32 in a round robin scheduling, thereby deciding the processing sequence of transmission instructions such that the transmission instructions received in the selected slave interfaces 31 and 32 are subsequently processed.

Then, for example, the adjustment unit 133 gives an access right to the plurality of transmission instructions, which have been received through the plurality of slave interfaces 31 and 32, in the decided processing sequence, and sequentially provides the transmission instructions to the memory control block 35.

In addition, the memory control block 35 alternately writes data corresponding to a transmission instruction from the master device 22 and data corresponding to a transmission instruction from the master device 24 on the high speed memory M1, according to the processing sequence decided by the adjustment unit 133. Also, the memory control block 35 alternately reads data corresponding to the transmission instruction from the master device 22 and data corresponding to the transmission instruction from the master device 24 from the high speed memory M1, according to the processing sequence decided by the adjustment unit 133.

As described above, the memory control block 35 sequentially processes a just previously unselected master device among the plurality of master devices 21 to 24 in a cyclic manner (i.e., in a round robin scheduling). Consequently, when viewed from the entire data transmission system 100, it is possible to average loads when processing the transmission instructions of the plurality of master devices 21 to 24, resulting in the improvement of the operation efficiency of the data transmission system 100.

### Third Embodiment

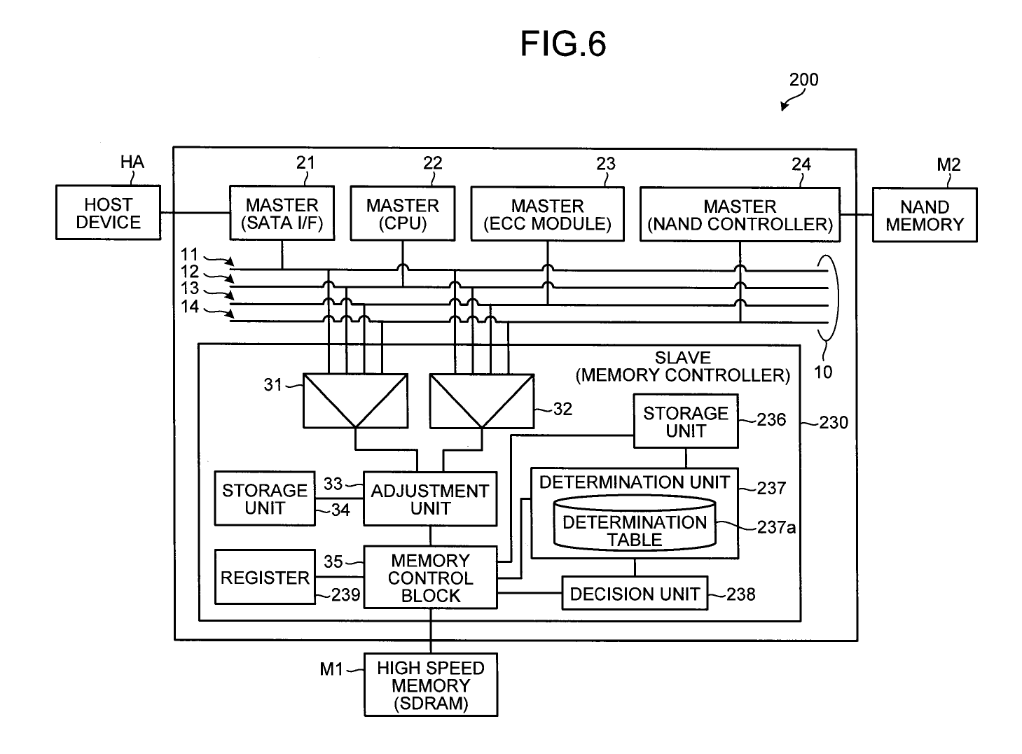

Next, a data transmission system 200 according to a third embodiment will be described with reference to FIG. 6. FIG. 6 is a diagram illustrating the configuration of the data transmission system 200 according to the third embodiment.

The data transmission system 200 includes a slave device 230. The slave device 230 includes a storage unit 236, a determination unit 237, a decision unit 238, and a register 239.

When a transmission instruction has been processed by the memory control block 35, the storage unit 236 receives the processed transmission instruction from the memory control block 35. Then, the storage unit 236 stores the just previously processed transmission instruction until a following transmission instruction is processed by the memory control block 35.

Furthermore, the register 239 receives the content of the transmission instruction, which has been processed by the memory control block 35, from the memory control block 35. Then, the register 239 stores the content of the transmission instruction processed by the memory control block 35. At this time, the register 239 includes a plurality of storage units. The memory control block 35 recognizes an address space of each storage unit in the register 239 and an address space of each memory cell in the high speed memory M1 as continuous address spaces.

The determination unit 237 determines the process speed of a data transmission process with respect to transmission instructions received in the selected slave interfaces 31 and 32 in consideration of the relation to the transmission instruction stored in the storage unit 236.

Specifically, the determination unit 237 determines process speeds for transmission instructions such that among the transmission instructions received in the selected slave interfaces 31 and 32, a process speed for a transmission instruction with an address near to an address of the transmission instruction stored in the storage unit 236 is higher than a process speed for a transmission instruction with an address far from the address of the transmission instruction stored in storage unit 236.

That is, since the content of the transmission instruction just previously processed by the memory control block 35 is stored in the register 239, in the case of the transmission instruction of the address which is near the address of the transmission instruction stored in the storage unit 236, it is estimated that the memory control block 35 can access the register 239 and process the transmission instruction at a high speed without accessing the high speed memory M1. Furthermore, in the case of the transmission instruction of the address which is near the address of the transmission instruction stored in the storage unit 236, a count up/down operation for an address value of a just previous address is also reduced. From this aspect, it is estimated that the transmission instruction can be processed at a high speed. That is, in the case where the high speed memory M1 is an SDRAM, if continuous addresses (no change in a RAS) are continued, it is possible to reduce a command issue cycle for the high speed memory M1, resulting in the reduction of access latency.

From this point of view, the determination unit 237 determines process speeds for transmission instructions such that among the transmission instructions received in the selected slave interfaces 31 and 32, a process speed for a transmission instruction with an address near to an address of the transmission instruction stored in the storage unit 236 is higher than a process speed for a transmission instruction with an address far from the address of the transmission instruction stored in storage unit 236.

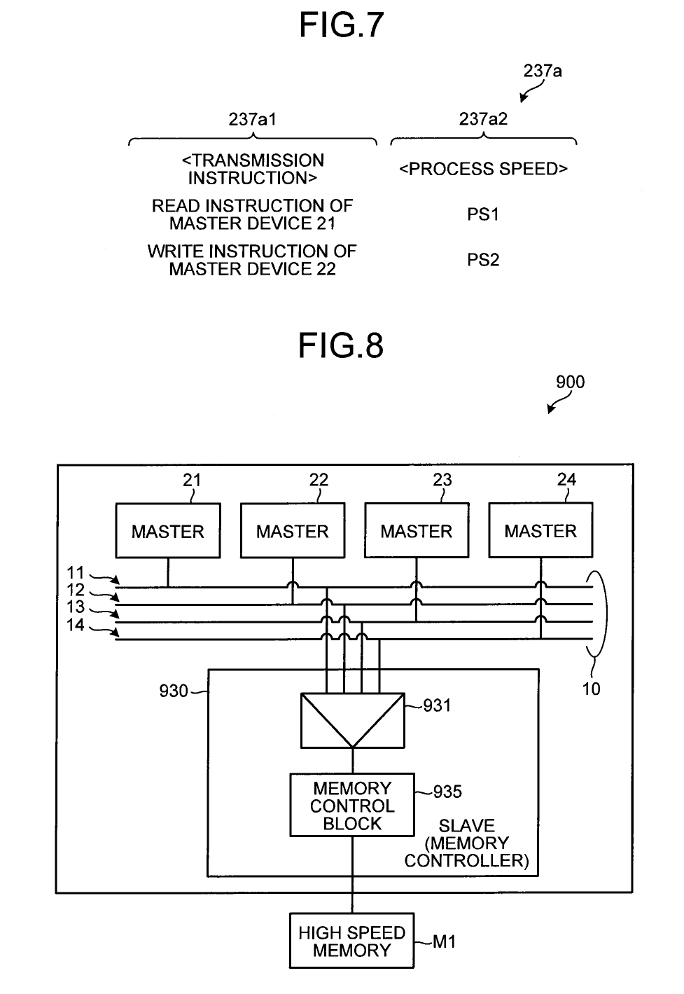

For example, there may be a case where the plurality of slave interfaces 31 and 32 receive a read instruction of the master device 21 and a write instruction of the master device 22 in a predetermined time at which receptions can be considered to be performed simultaneously. The determination unit 237 determines that an address of the write instruction of the master device 22 is near the address of the transmission instruction stored in the storage unit 236, as compared with an address of the read instruction of the master device 21. At this time, the determination unit 237 determines that a process speed PS2 of the write instruction of the master device 22 is higher than a process speed PS1 of the read instruction of the master device 21 (PS1<PS2). Then, the determination unit 237 dynamically generates a determination table 237a (refer to FIG. 7), which indicates a determination result, and provides the determination table 237a to the decision unit 238.

Specifically, as illustrated in FIG. 7, the determination table 237a includes a transmission instruction field 237a1 and a process speed field 237a2. In the transmission instruction filed 237a1, information (e.g., the “read instruction of the master device 21” and the “write instruction of the master device 22”) for identifying transmission instructions is recorded. In the process speed field 237a2, the process speeds PS1 and PS2 of corresponding transmission instructions are recorded. The process speeds PS1 and PS2 of the transmission instructions have been decided in consideration of the relation to the transmission instruction stored in the storage unit 236.

The decision unit 238 receives the information of the determination table 237a (refer to FIG. 7) from the determination unit 237. The decision unit 238 decides the processing sequence of the transmission instructions received through the plurality of slave interfaces 31 and 32 with reference to the determination table 237a indicating a determination result obtained by the determination unit 237. Specifically, the decision unit 238 decides the processing sequence of the transmission instructions such that a transmission instruction with a high processing speed takes priority over a transmission instruction with a low processing speed.

For example, when it is determined by the determination table 237a that the process speed PS2 of the write instruction of the master device 22 is higher than the process speed PS1 of the read instruction of the master device 21 (PS1<PS2), the decision unit 238 decides the processing sequence of the transmission instructions such that the write instruction of the master device 22 takes priority over the read instruction of the master device 21.

At this time, the decision unit 238 provides a change request to the adjustment unit 33 through the memory control block 35 such that the processing sequence decided by the adjustment unit 33 is changed (a sequence is switched) according to the decided processing sequence of the transmission instructions. Accordingly, the adjustment unit 33 changes the processing sequence decided by the adjustment unit 33 using the processing sequence of the transmission instructions decided by the decision unit 238, gives an access right to the changed transmission process sequence, and sequentially provides the changed transmission process sequence to the memory control block 35.

Then, the memory control block 35 performs a data transmission process with respect to the high speed memory M1 corresponding to the transmission instructions according to the processing sequence decided by the decision unit 238. That is, the memory control block 35 performs the data transmission process with respect to the high speed memory M1 corresponding to the transmission instructions based on the processing sequence changed by the adjustment unit 33 according to the processing sequence decided by the decision unit 238.

As described above, the memory control block 35 preferentially processes a transmission instruction having an adjacent address with reference to the just previously processed transmission instruction. Consequently, when viewed from the entire data transmission system 200, it is possible to reduce the processing time for the transmission instruction of the master device 21 and the transmission instruction of the master device 22, resulting in the improvement of the operation efficiency of the data transmission system 200.

It should be noted that the plurality of master devices 21 to 24 may include a first master device that outputs larger number of read instructions than write instructions as transmission instructions, and a second master device that outputs larger number of write instructions than read instructions as transmission instructions. For example, the plurality of master devices 21 to 24 may include the master device 21 as the first master device and the master device 22 as the second master device. In such a case, when the transmission instruction stored in the storage unit 236 is the write instruction, the determination unit 237 determines that a processing speed for a transmission instruction received in the first master device is higher than a processing speed for a transmission instruction received in the second master device.

For example, when the transmission instruction stored in the storage unit 236 is the write instruction, the determination unit 237 determines that the process speed PS1 of the read instruction of the master device 21 is higher than the process speed PS2 of the write instruction of the master device 22 (PS1>PS2) (refer to FIG. 7). Then, as it is determined by the determination table 237a that the process speed PS1 of the read instruction of the master device 21 is higher than the process speed PS2 of the write instruction of the master device 22 (PS1>PS2), the decision unit 238 decides the processing sequence of transmission instructions such that the read instruction of the master device 21 takes priority over the write instruction of the master device 22.

Alternatively, for example, when the transmission instruction stored in the storage unit 236 is the read instruction, the determination unit 237 determines that the process speed PS2 of the write instruction of the master device 22 is higher than the process speed PS1 of the read instruction of the master device 21 (PS1<PS2) (refer to FIG. 7). Then, as it is determined by the determination table 237a that the process speed PS2 of the write instruction of the master device 22 is higher than the process speed PS1 of the read instruction of the master device 21 (PS1<PS2), the decision unit 238 decides the processing sequence of transmission instructions such that the write instruction of the master device 22 takes priority over the read instruction of the master device 21.

Then, the memory control block 35 performs a data transmission process with respect to the high speed memory M1 corresponding to the transmission instructions according to the processing sequence decided by the decision unit 238. That is, the memory control block 35 performs the data transmission process with respect to the high speed memory M1 corresponding to the transmission instructions based on the processing sequence changed by the adjustment unit 33 according to the processing sequence decided by the decision unit 238.

As described above, the memory control block 35 preferentially processes a transmission instruction with an inverse transmission direction with reference to the just previously processed transmission instruction. That is, a circuit (not illustrated) for adjusting the authority to use the bus 10 allocates the authority to use the bus 10 to different master devices 21 to 24 in a predetermined time for which receptions can be considered to be performed simultaneously among the plurality of slave interfaces 31 and 32. Therefore, the preferential processing of the transmission instruction with an inverse transmission direction with reference to the just previously processed transmission instruction corresponds to the preferential processing of a transmission instruction of a master device, which is different from the just previously processed transmission instruction. For example, if the just previously processed transmission instruction is the transmission instruction (read processing) of the master device 21, the transmission instruction (write processing) of the master device 22 is preferentially processed in the next. If the just previously processed transmission instruction is the transmission instruction (write processing) of the master device 22, the transmission instruction (read processing) of the master device 21 is preferentially processed in the next. Consequently, the transmission instruction (read processing) of the master device 21 and the transmission instruction (write processing) of the master device 22 can be partially performed in parallel. That is, when viewed from the entire data transmission system 200, it is possible to reduce the processing time for the transmission instruction of the master device 21 and the transmission instruction of the master device 22, resulting in the improvement of the operation efficiency of the data transmission system 200.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor apparatus comprising:
a bus including a plurality of lines, the bus transmitting data at a first frequency;
a plurality of master devices connected to the bus; and
a slave device connected to the bus,
wherein the slave device includes:
a plurality of slave interfaces connected to the bus to receive transmission instructions from the master devices at the first frequency through the bus;
an adjustment unit which decides a processing sequence of the transmission instructions which are received through the plurality of slave interfaces, according to priority information on which the plurality of master devices are prioritized in a sequence depending on associations of processing contents among the plurality of master devices; and
a processing unit which performs a data transmission process corresponding to a transmission instruction at a second frequency according to the processing sequence decided by the adjustment unit, the transmission instruction instructing to transform data to/from a module, the second frequency being higher than the first frequency.

2. The semiconductor apparatus according to claim 1, wherein
the slave device further includes a storage unit which stores a priority designation table in which identifiers of master devices and priorities of master devices are corresponds to each other with respect to the plurality of master devices.

3. The semiconductor apparatus according to claim 2, wherein
the adjustment unit decides the processing sequence in a sequence of selected master devices with respect to the transmission instructions received through the plurality of slave interfaces by sequentially selecting from a master device with a high priority to a master device with a low priority in the priority designation table in a cyclic manner.

4. The semiconductor apparatus according to claim 1, wherein
the adjustment unit decides the processing sequence of the transmission instructions received through the plurality of slave interfaces such that a process performed by a first master device and a process performed by a second master device are alternately performed according to the priority information.

5. The semiconductor apparatus according to claim 1, wherein
the module includes a memory which operates at a third frequency higher than the first frequency,
the second frequency corresponds to the third frequency, and
when a transmission instruction is a write instruction, the processing unit writes predetermined data on the memory according to the write instruction, or when a transmission instruction is a read instruction, the processing unit reads predetermined data from the memory according to the read instruction.

6. A semiconductor apparatus comprising:
a bus including a plurality of lines, the bus transmitting data at a first frequency;
a plurality of master devices connected to the bus; and
a slave device connected to the bus,
wherein the slave device includes:
a plurality of slave interfaces connected to the bus to receive transmission instructions from the master devices at the first frequency through the bus;
an adjustment unit which decides a processing sequence of the transmission instructions which are received through the plurality of slave interfaces, according to priority information on which the plurality of master devices are prioritized in a higher order of processing ability of the master devices; and
a processing unit which performs a data transmission process corresponding to a transmission instruction at a second frequency according to the processing sequence decided by the adjustment unit, the transmission instruction instructing to transform data to/from a module, the second frequency being higher than the first frequency.

7. The semiconductor apparatus according to claim 6, wherein
the slave device further includes a storage unit which stores a priority designation table in which identifiers of master devices and priorities of master devices are corresponds to each other with respect to the plurality of master devices.

8. The semiconductor apparatus according to claim 7, wherein
the adjustment unit decides the processing sequence in a sequence of selected master devices with respect to the transmission instructions received through the plurality of slave interfaces while the adjustment unit sequentially selects from a master device with a high priority to a master device with a low priority in the priority designation table in a cyclic manner.

9. The semiconductor apparatus according to claim 1, wherein
the module includes a memory which operates at a third frequency higher than the first frequency,
the second frequency corresponds to the third frequency, and
when a transmission instruction is a write instruction, the processing unit writes predetermined data on the memory according to the write instruction, or when a transmission instruction is a read instruction, the processing unit reads predetermined data from the memory according to the read instruction.

10. A semiconductor apparatus comprising:
a bus including a plurality of lines, the bus transmitting data at a first frequency;
a plurality of master devices connected to the bus; and
a slave device connected to the bus,
wherein the slave device includes:
a plurality of slave interfaces connected to the bus to receive transmission instructions from the different master devices at the first frequency through the bus;
an adjustment unit which decides a processing sequence of the transmission instructions which are received through the plurality of slave interfaces, by selecting the plurality of slave interfaces in a round robin scheduling; and
a processing unit which performs a data transmission process corresponding to a transmission instruction at a second frequency according to the processing sequence decided by the adjustment unit, the transmission instruction instructing to transform data to/from a module, the second frequency being higher than the first frequency.

11. The semiconductor apparatus according to claim 10, wherein
the module includes a memory which operates at a third frequency higher than the first frequency,
the second frequency corresponds to the third frequency, and
when a transmission instruction is a write instruction, the processing unit writes predetermined data on the memory according to the write instruction, or when a transmission instruction is a read instruction, the processing unit reads predetermined data from the memory according to the read instruction.

12. A semiconductor apparatus comprising:
a bus including a plurality of lines, the bus transmitting data at a first frequency;
a plurality of master devices connected to the bus; and
a slave device connected to the bus,
wherein the slave device includes:
a plurality of slave interfaces connected to the bus to receive transmission instructions from the master devices at the first frequency through the bus;
a storage unit which stores a just previously processed transmission instruction;
a determination unit which determines a process speed of a data transmission process with respect to the transmission instructions received through the plurality of slave interfaces in consideration of a relation to the transmission instruction stored in the storage unit;
a decision unit which decides a processing sequence of the transmission instructions received through the plurality of slave interfaces according to a determination result obtained by the determination unit; and
a processing unit which performs a data transmission process corresponding to a transmission instruction at a second frequency according to the processing sequence decided by the adjustment unit, the transmission instruction instructing to transform data to/from a module, the second frequency being higher than the first frequency.

13. The semiconductor apparatus according to claim 12, wherein
the determination unit dynamically generates a determination table in which a transmission instruction and a process speed correspond to each other with respect to the transmission instructions received through the plurality of slave interfaces, and
the decision unit decides the processing sequence of the transmission instructions received through the plurality of slave interfaces according to the generated determination table.

14. The semiconductor apparatus according to claim 12, wherein
the slave device further includes an adjustment unit which decides the processing sequence of the transmission instructions received through the plurality of slave interfaces, and
wherein the decision unit provides a change request to the adjustment unit such that the processing sequence decided by the adjustment unit is changed by the decided processing sequence of the transmission instructions, and
the adjustment unit changes the processing sequence of the transmission instructions decided by the adjustment unit according to the processing sequence of the transmission instructions decided by the decision unit, gives an access right to a changed transmission process sequence, and sequentially provides the changed transmission process sequence to the processing unit.

15. The semiconductor apparatus according to claim 12, wherein
the determination unit determines process speeds for transmission instructions such that, among the transmission instructions received through the plurality of slave interfaces, a process speed for a transmission instruction with an address near to an address of the transmission instruction stored in the storage unit is higher than a process speed for a transmission instruction with an address far from the address of the transmission instruction stored in the storage unit, and
the decision unit decides the processing sequence of the transmission instructions such that a transmission instruction with a high process speed takes priority over a transmission instruction with a low process speed.

16. The semiconductor apparatus according to claim 15, wherein
the module includes a memory which operates at a third frequency higher than the first frequency,
the second frequency corresponds to the third frequency.

17. The semiconductor apparatus according to claim 16, wherein
the slave device further includes a register which stores content of the transmission instruction processed by the processing unit, and
the processing unit recognizes an address space of each storage unit in the register and an address space of each memory cell of the memory as continuous address spaces.

18. The semiconductor apparatus according to claim 12, wherein
the plurality of master devices includes:
a first master device which outputs larger number of read instructions than write instructions as transmission instructions; and
a second master device which outputs larger number of write instructions than read instructions as transmission instructions,
the determination unit determines that a process speed of a transmission instruction received from the first master device is higher than a process speed of a transmission instruction received from the second master device when the transmission instruction stored in the storage unit is the write instruction, and determines that the process speed of the transmission instruction received from the second master device is higher than the process speed of the transmission instruction received from the first master device when the transmission instruction stored in the storage unit is the read instruction, and
the decision unit decides the processing sequence of the transmission instructions such that a transmission instruction with a high process speed takes priority over a transmission instruction with a low process speed.

19. The semiconductor apparatus according to claim 18, wherein
the module includes a memory which operates at a third frequency higher than the first frequency,
the second frequency corresponds to the third frequency.

20. The semiconductor apparatus according to claim 19, wherein
when a transmission instruction is the write instruction, the processing unit writes predetermined data in the memory according to the write instruction, and when a transmission instruction is the read instruction, the processing unit reads predetermined data from the memory according to the read instruction.
